(19) United States
(12) Patent Application Publication
(10) Pub. No.: US 2008/0054581 A1
(43) Pub. Date: Mar. 6, 2008

(54) Hand truck having a collapsible and adjustable support apparatus

(76) Inventor: Randall Voth, (US)

Correspondence Address: JAMES RAY & ASSOCIATES, 2640 PITCHAIRN ROAD, MONROEVILLE, PA, 15146, US

(21) Appl. No.: 11/895,918

(22) Filed: Aug. 28, 2007

Related U.S. Application Data
(60) Provisional application No. 60/841,021, filed on Aug. 30, 2006.

(51) Int. Cl. B62B 1/04

(52) U.S. Cl. 280/40; 280/47.27

(57) ABSTRACT

A support apparatus for transporting a load on a hand truck in a safe and balanced manner includes a base which is disposed generally horizontally when the hand truck is employed for transporting such load and a pivot means for pivotally connecting a first end of the base to the axle intermediate the pair of wheels of the hand truck. Two auxiliary wheels are attached to an opposed second end of the base. A frame support is disposed generally vertically when the hand truck is employed for transporting such load and has a first end thereof connected to the base and has a second end thereof abutting the portion of the hand truck. A brace has a first end thereof connected to the base adjacent to and spaced from the first end of the base and has a second end thereof connected to the frame support adjacent to and spaced from the first end thereof.

### CROSS-REFERENCE TO RELATED APPLICATIONS

This application is related to and claims priority from U.S. Provisional Patent Application Ser. No. 60/841,021 filed on Aug. 30, 2006.

### FIELD OF THE INVENTION

The present invention relates, in general, to hand trucks and, more particularly, this invention relates to a hand truck having a collapsible and adjustable support apparatus for transporting a load in a safe and balanced manner.

### BACKGROUND OF THE INVENTION

As is generally well known, conventional hand trucks and, more particularly, two wheel hand truck includes a load support frame, a pair of wheels which are pivotally connected to an axle mounted to a lower portion of the frame, a load supporting platform which is fixed to the front side of the frame and which normally engages the ground for receiving the load. After the load is supported on the platform, the user pushes upper end of the support frame down and fulcrums it about the pair of wheels to a desired angle in order to let the platform to leave the ground and in order to properly balance the load. The user can then transport the load by pushing or pulling the hand truck. While transporting the load, the user is tasked with balancing both the hand truck and the load. Often, when an elongated bulky and heavy load extends past the upper portion of the hand truck, the user must exert greater than desired effort by operating and balancing the hand truck with one hand while holding the load with the other hand in order to prevent it from falling off the hand truck when simple obstacles such as electrical cords are encountered. When the user must transport loads under the above described condition for long periods of time, injury can result due to strained muscles.

Efforts have been made to alleviate difficulties of balancing and transporting bulky load on a hand truck. Some hand trucks, presently in use, include an auxiliary frame which is rigidly secured to the load support frame and a pair of auxiliary wheels connected to the auxiliary frame enabling the user to tilt the load support frame and transport the load at a fixed angle. However, it has been found that such fixed tilt angle of the load support frame does not enable safe and stable transporting of all loads. Furthermore, a greater than desirable effort is required to retrofit the conventional hand trucks with such auxiliary frame.

U.S. Pat. No. 4,681,330 issued to Misawa discloses a hand truck which has an auxiliary frame being pivotally mounted on the lower portion of the load supporting frame and having a pair of auxiliary wheels provided on ends thereof. An extensible cylinder device is provided between the load supporting frame and the auxiliary frame. An operating device is connected to the cylinder and is operable by the user so as to change the angle there-between in order to balance the load. However, the use of the cylinder and its operating device increase maintenance costs of such hand truck and still require greater than desirable effort is required to retrofit the conventional hand trucks.

Therefore, there is a need for an improved apparatus which enables safe and balanced transporting of the bulky loads.

### SUMMARY OF THE INVENTION

The invention provides a support apparatus for transporting a load on a hand truck in a safe and balanced manner. The hand truck includes a load supporting frame. A load carrying member is disposed on and secured to a lower portion of the load supporting frame. An axle is mounted adjacent such lower portion and a wheel is disposed on and secured to a respective end of the axle. A handle is formed in an upper portion of the load supporting frame. The support apparatus includes a base which is disposed generally horizontally when the hand truck is employed for transporting such load. A pivot means is provided for pivotally connecting a first end of the base to the axle intermediate the pair of wheels of the hand truck. A pair of auxiliary wheels are attached to an opposed second end of the base. A frame support is disposed generally vertically when the hand truck is employed for transporting such load. The frame support has a first end thereof configured for abutting engagement with the load supporting frame of the hand truck being disposed at a predetermined angle relative to the base and has a second end thereof connected to the base adjacent the second end thereof. A brace has a first end thereof connected to the base adjacent to and spaced from the first end thereof and has a second end thereof connected to the frame support adjacent to and spaced from the first end thereof.

### OBJECTS OF THE INVENTION

It is, therefore, one of the primary objects of the present invention to provide a support apparatus for a hand truck which enables transporting a load in a safe and balanced manner.

Another object of the present invention is to provide a support apparatus for a hand truck which is adjustable.

Yet another object of the present invention is to provide a support apparatus for a hand truck which is collapsible.

A further object of the present invention is to provide a support apparatus for a hand truck which can be easily attached to hand trucks currently in use.

Yet a further object of the present invention is to provide a support apparatus for a hand truck which is economical to manufacture.

An additional object of the present invention is to provide a support apparatus for a hand truck which is simple to use.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a front elevation view of a support apparatus for a hand truck which is constructed according to one embodiment of the invention;

FIG. 2 is a front elevation view of a support apparatus for a hand truck which is constructed according to another embodiment of the invention and which is shown for use in a first position;

FIG. 3 is a side elevation view of the support apparatus of FIG. 2;

FIG. 4 is a top view of the support apparatus of FIG. 2;

FIG. 5 is a front elevation view showing the support apparatus of FIG. 2 shown for use in a second position;

FIG. 6 is a front elevation view showing the support apparatus of FIG. 2 in a folded condition; and

FIG. 7 is a cross-sectional view along lines 7-7 of FIG. 4, particularly illustrating means for setting length of telescopically adjustable members of the apparatus of FIG. 2.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

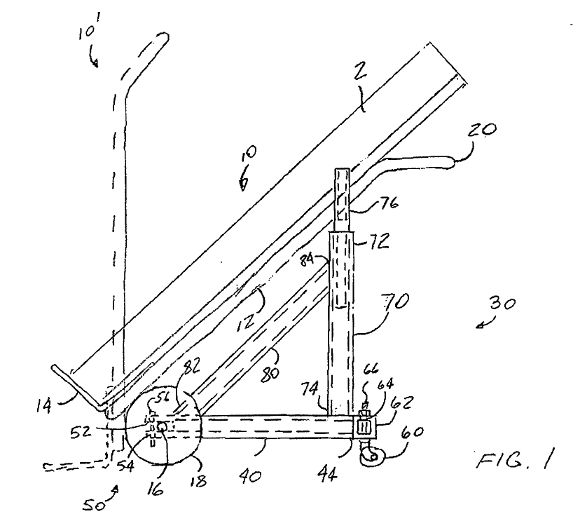

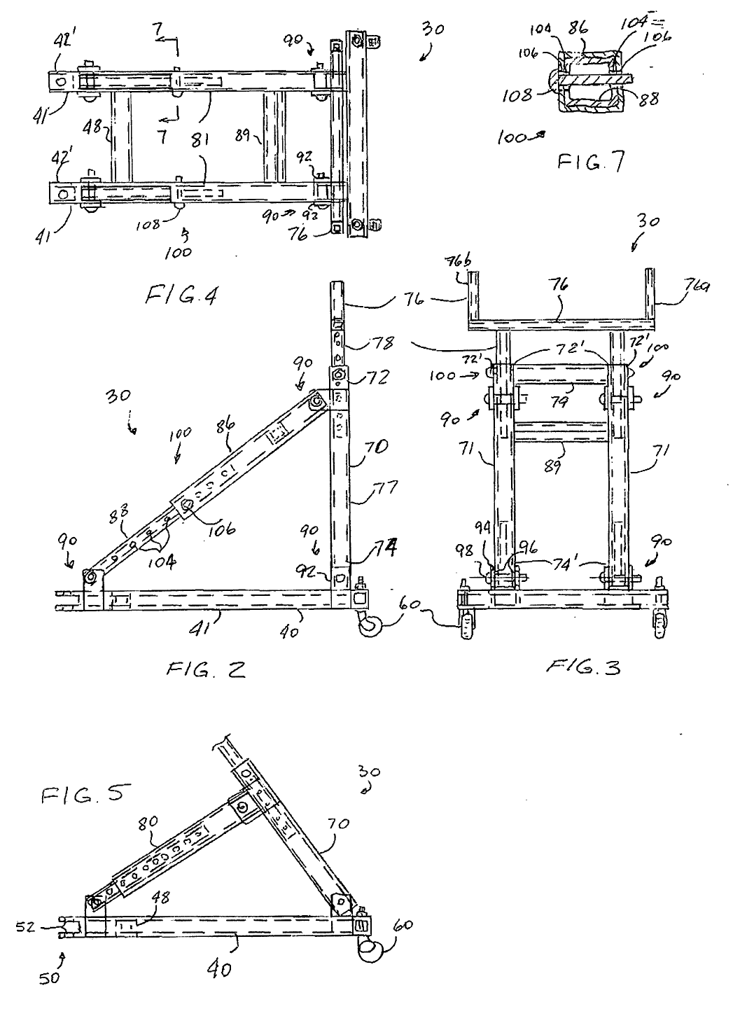

Reference is now made, to FIGS. 1-7, wherein there is shown a hand truck, generally designated 10, for transporting a load 2. The hand truck 10 includes a load supporting frame 12, a load carrying member, such as a simple platform 14, an axle 16 which is attached to a lower portion of the load supporting frame 12, a pair of wheels 18 operably mounted on each end of the axle 16 and a handle 20 formed in the upper portion of load supporting frame 12. For transporting such load 2 in a safe and balanced manner, the present invention provides a support apparatus, generally designated as 30, which is used in combination with the hand truck 10.

One essential element of the apparatus 30 is a base 40 which is disposed generally horizontally when the hand truck 10 is employed for transporting such load 2. Another essential element is a pivot means, generally designated as 50, which is provided for pivotally connecting a first end 42 of the base 40 to the axle 16 intermediate the pair of wheels 18 of the hand truck 10. A pair of auxiliary wheels 60 are attached to an opposed second end 44 of the base 40.

A further essential element of the apparatus 30 is a frame support 70 which is disposed generally vertically when the hand truck 10 is employed for transporting such load 2. The frame support 70 has a first end 72 thereof configured for abutting engagement with the load supporting frame 12 of the hand truck 10 being disposed at a predetermined angle relative to the base 40. A second end 74 of the frame support 70 is connected to the base 40 adjacent the second end 44 thereof.

A final essential element of the apparatus 30 is a brace 80 which has a first end 82 thereof connected to the base 40 adjacent to and spaced from the first end 42 thereof and which has a second end 84 thereof connected to the frame support 70 adjacent to and spaced from the first end 72 thereof.

According to one embodiment of the invention, each of the base 40, the frame support 70 and the brace 80 is formed as a simple elongated member, preferably from a tubular material to reduce the weight of the apparatus 30. Advantageously, the pivot means 50 includes a cutout 52 which is formed horizontally through the base 40 in open relationship with its first end 42 and which is sized to receive therewithin the axle 16 of the hand truck 10. An aperture 54 is vertically formed through the base 40 adjacent and spaced from the first end 42 and through the cutout 52. An elongated fastener 56, preferably a simple pin, is received within the aperture 54 after the axle 16 has been received within the cutout 52 for pivotal caging therewithin.

To attach the pair of auxiliary wheels 60, an elongated member 62 is rigidly attached to the second end 44 of the base 40 and is disposed generally perpendicular to the base 40 and generally parallel to the axle 16. A pair of apertures 64 are formed adjacent each end of the elongated member 62 and each wheel 60, which is preferably of a swivel caster type having a threaded stem 66, is attached to the elongated member 62 by inserting the threaded stem 66 through the aperture 64 and securing it with a simple threaded nut 68.

The first end 72 of the frame support 70 includes a U-shaped cradle portion 76 which is disposed in a vertical direction and which is sized to securely receive a portion of the load supporting frame 12 between a pair of vertical members 76a and 76b of the U-shaped cradle portion 76. The presently preferred size of the cradle portion 76 is about 14 inches wide and about 4 high.

To use the apparatus 30, the user simply secures the axle 16 within the cut-out 52 with the pin 56. The user then places the load 2 onto the load carrying member 14 while the load supporting frame 12 is disposed vertically as shown by 10′ in FIG. 1 and tilts the load supporting frame 12 in a clockwise direction in FIG. 1 to engage a portion thereof with the first end 72 of the frame support 70 and, more particularly, with the horizontally disposed member 76c of the U-shaped cradle portion 76. With the load supporting frame 12 resting on such horizontally disposed member 76c, the user then simply transports the load 2 in a balanced manner afforded by the apparatus 30 and further without the need to continuously hold the load 2 as it is being restricted from lateral movement by the pair of vertical members 76a and 76b. The length of each member 76a and 76b is about 4 inches and the length of the members 76c is about 14 inches. When the load 2 is transported to a desired location, the user disengages the portion of the load support frame 12 from the first end 72 of the frame support 70 and rotates it in a counter-clockwise direction to remove the load 2 from the load carrying member 14. If required, for storage or other purposes, the user simply removes the pin 56 and disengages the axle 16 from the cutout 52 and, more particularly, separates the apparatus 30 from the hand truck 10. If further required, the user can then use the apparatus 30 of the present invention with a different hand truck.

To minimize storage space requirements for storing the apparatus 30, it has been found advantageous to pivotally connect the frame support 70 to the base 40 and further pivotally connect the brace 80 to both the base 40 and the frame support 70. It has been further found advantageously to employ identical pivot means for such various pivotal connections. Accordingly, the apparatus 30 employs a plurality of pivot means, generally designated as 90, for pivotally connecting various members therebetween. For the sake of brevity, the structure and operation of the pivot means 90 will be described for connecting the second end 74 of the frame support 70 to the second end 44 of the base 40. In accordance with a presently preferred embodiment of the invention, such pivot means 90 includes a pair of planar brackets 92 which are rigidly secured to the base 40, for example by a welding process, adjacent to and spaced from the second end 44 thereof and in a spaced and parallel relationship to each other. A first aperture 94 is formed through a first planar bracket 92 and has an axis thereof aligned in horizontal direction with the axis of another first aperture 94 which is formed through the second planar bracket 92. A second aperture 96 is formed through the frame support 70 adjacent and spaced from the second end 74 thereof. A pin member 98 is inserted through the first and second apertures 94 and 96 respectively when the second end 74 of the frame support 70 is positioned between the spaced planar brackets 92 and when the second aperture 96 is aligned with the pair of first apertures 94. Thus, when it is required to store the apparatus 30 in tight confines, the user removes pin 98 which pivotally connects the brace 80 to the frame support 70 and juxtaposes the brace 80 and frame support 70 about the base 40, as best shown in FIG. 6. The user may remove remaining pins 98 if it required to further minimize space envelop of the apparatus 30.

In order to employ apparatus 30 with any hand truck construction, the brace 80 is formed by a pair of telescopically adjustable elongated members 86 and 88. It will be appreciated that one of the elongated members 86 and 88, shown as 88 in FIG. 2, is sized to move linearly within the larger elongated member 86. It is also within the scope of the present invention to provide means, generally designated as 100, for setting a predetermined length of the brace 80 thus enabling the frame support 70 to be positioned in one of a first position being generally perpendicular to the base 40, as best shown in FIG. 2, and a second position being disposed at a second predetermined angle relative to the base 40, as best shown in FIG. 5. Now in a particular reference to FIG. 7 and in accordance with the presently preferred embodiment of the invention, the means 100 for setting the predetermined length of the brace 80 includes a plurality of spaced apart first apertures 104 formed in one of the pair of telescopically adjusted elongated members 86 and 88, a second aperture 106 which is formed through an opposed one of the pair of telescopically adjusted elongated members 86 and 88, and a pin member 108 which is inserted through the second aperture 106 and through a preselected one of the plurality of the first apertures 104 which is aligned with the second aperture 106.

Alternatively, the means 100 for setting the predetermined length of the brace 80 may be a well known friction fit.

It has been also found advantageous, for preselecting the angle of the load support frame 12, to adjust the position of the U-shaped cradle portion 76 relative to the first end 72 of the frame support 70 by employing a pair of telescopically adjustable elongated members 77 and 78 wherein one member, shown as 77 by way of an example only in FIGS. 2-3, incorporates the first end 72 and the second end 74 of the frame support 70 and wherein the opposed elongated member 78 is rigidly attached to the U-shaped cradle portion 76. Preferably, each of the elongated members 77 and 78 has a tubular shape. The means 100 is further employed for setting a predetermined length of the frame support 70.

While the base 40, the frame support 70 and the brace 80 consisting of a single elongated member either fixed or adjustable in length has been found sufficient for variety of different applications, it has been determined necessary for supporting and balancing heavy loads to form each of the base 40, the frame support 70 and the brace 80 as a frame portion consisting of two spaced apart elongated members. Accordingly, the base 40 includes a pair of spaced-apart elongated members 41 which are disposed generally perpendicular to the axle 16 of the hand truck 10. First ends 42′ of the pair of elongated members 41 form the first end 42 of the base 40. The elongated member 62 is rigidly secured to opposed second ends 44′ of the pair of elongated members 41 and forms in combination therewith a second end 44 of the base 40. An optional brace 48 may be rigidly secured to both elongated members 41 adjacent to and spaced from the first end 42 to increase rigidity of the base 40. The presently preferred size of the base 40 is about 12 inches wide and about 22 inches long. It will be understood that the first pivot means 50 will be now a pair of first pivot means 50 each for pivotally connecting a respective first end 41′ of one of the pair of spaced-apart elongated members 41 of the base 40 to the axle 16 intermediate the pair of wheels 18 of the hand truck 10.

Furthermore, the frame support 70 will now include a pair of spaced-apart tubular members 71 each having a first end 72′ and an opposed second end 74′ and formed, according the most presently preferred embodiment of the invention, by a pair of telescopically adjustable elongated members 77 and 78. An optional brace 79 may be rigidly secured to both elongated members 71 adjacent to and spaced from the second end 74 to increase rigidity of the frame support 70.

To mate with a pair of elongated member 41 of the base 40 and the aligned pair of elongated members 71 of the frame support 70, the brace 80 now includes a pair of spaced-apart elongated members 81 each formed by a pair of above described telescopically adjustable elongated members 86 and 88. An optional brace 89 may be rigidly secured to both elongated members 81 adjacent to and spaced from the second end 84 to increase rigidity of the brace 80.

Thus, the apparatus 10 which is constructed to the presently preferred embodiment of the invention is adjustable to various length and/or positions to accommodate loads 2 of different weights and sizes. For example, when the load 2 is a fully loaded 55-galon drum, it has been found advantageous to adjust the apparatus 30 as shown in FIG. 5, in order to transport such 55-galon drum lower to the ground.

The use of pin and hole arrangement enables the user to easily attach the apparatus 30 to and remove it from the axle 16 of the hand truck 10. The apparatus 30 can be also easily folded for storage purposes independently from the hand truck 10.

The presently preferred material of each elongated member is steel, although, the present invention contemplates that lighter materials such as aluminum, plastic or composites may be equally employed within the apparatus 30.

The presently preferred size of the stationary or pivotal members has been preselected to be about 1.25 inches square tubing. The size of the telescopically moving elongated members is about 1.0 inch square tubing. The present invention also contemplates that each elongated member may be manufactured from a round tubing material.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. In combination with a hand truck for transporting a load and having a load supporting frame, a load carrying member disposed on and secured to a lower portion of said load supporting frame, an axle which is mounted adjacent said lower portion, a pair of wheels each disposed on and secured to a respective end of said axle, and a handle formed in an upper portion of said load supporting frame, a support apparatus for transporting such load in a safe and balanced manner, said apparatus comprising:
(a) a base which is disposed generally horizontally when said hand truck is employed for transporting such load;
(b) a pivot means for pivotally connecting a first end of said base to said axle intermediate said pair of wheels of said hand truck;
(c) a pair of auxiliary wheels attached to an opposed second end of said base;
(d) a frame support which is disposed generally vertically when said hand truck is employed for transporting such load, said frame support having a first end thereof configured for abutting engagement with said load supporting frame of said hand truck being disposed at a predetermined angle relative to said base and having a second end thereof connected to said base adjacent said second end thereof; and
(e) a brace having a first end thereof connected to said base adjacent to and spaced from said first end of said base and having a second end thereof connected to said frame support adjacent to and spaced from said first end thereof.

2. The apparatus, according to claim 1, wherein said apparatus includes a pivot means for pivotally connecting said second end of said frame support to said base.

3. The apparatus, according to claim 2, wherein said pivot means includes a pair of planar brackets rigidly secured to said base in a spaced and parallel relationship to each other, a pair of first apertures each formed through a respective planar bracket and having axis thereof aligned in a horizontal direction, a second aperture which is formed through said second end of said frame support, and a pin member which is inserted through said first and second apertures when said second end of said frame support is positioned between said spaced planar brackets and when said second aperture is aligned with said pair of first apertures.

4. The apparatus, according to claim 1, wherein said apparatus includes a pivot means for pivotally connecting said first end of said brace to said base.

5. The apparatus, according to claim 4, wherein said apparatus further includes a pivot means for pivotally connecting said second end of said brace to said frame support.

6. The apparatus, according to claim 1, wherein said base includes a pair of spaced-apart elongated members which are disposed generally perpendicular to said axle of said hand truck and a third elongated member which is disposed generally parallel to said axle when said hand truck is employed for transporting such load, wherein first ends of said pair of elongated members form said first end of said base, wherein said third elongated member is rigidly secured to opposed second ends of said pair of elongated members, and wherein second ends of said pair of elongated members in combination with said third elongated member form said second end of said base.

7. The apparatus, according to claim 6, wherein said pair of auxiliary wheels of said apparatus are pivotally secured to ends of said third elongated member.

8. The apparatus, according to claim 1, wherein said first end of said frame support is U-shaped for securely receiving a portion of said load carrying frame disposed adjacent and spaced from said handle of said hand truck.

9. The apparatus, according to claim 1, wherein said brace is formed by a pair of telescopically adjustable elongated members.

10. The apparatus, according to claim 9, wherein said apparatus includes means for setting a predetermined length of said brace enabling said frame support to be positioned in one of a first position being generally perpendicular to said base and a second position being disposed at a second predetermined angle relative to said base.

11. The apparatus, according to claim 10, wherein said means for setting said predetermined length of said brace includes a plurality of spaced apart first apertures formed in one of said pair of telescopically adjustable elongated members, a second aperture which is formed through an opposed one of said pair of telescopically adjustable elongated members, and a pin member which is inserted through said second aperture and through a preselected one of said plurality of said first apertures which is aligned with said second aperture.

12. The apparatus, according to claim 10, wherein said means for setting said predetermined length of said brace is a friction fit.

13. The apparatus, according to claim 1, wherein said frame support is formed by a pair of telescopically adjustable elongated members, wherein a first one of said pair of telescopically adjustable elongated members incorporates said first end of said frame support and wherein a second one of said pair of telescopically adjustable elongated members incorporates said second end of said frame support.

14. The apparatus, according to claim 1, wherein each of said base, said frame support and said brace is formed from a tubular material.

15. In combination with a hand truck for transporting a load and having a load supporting frame, a load carrying member disposed on and secured to a lower portion of said load supporting frame, an axle which is mounted adjacent such lower portion, a pair of wheels each disposed on and secured to a respective end of said axle, and a handle formed in an upper portion of said load supporting frame, an apparatus for transporting such load in a safe and balanced manner, said apparatus comprising:
(a) a base which is disposed generally horizontally when said hand truck is employed for transporting such load, said base includes a pair of spaced-apart elongated members which are disposed generally perpendicular to said axle and a third elongated member which is disposed generally parallel to said axle, wherein said third elongated member is rigidly secured to second ends of said pair of spaced-apart elongated members;
(b) a pair of first pivot means each for pivotally connecting a respective first end of one of said pair of spaced-apart elongated members of said base to said axle intermediate said pair of wheels of said hand truck;
(c) a pair of auxiliary wheels each pivotally secured to each end of said third elongated member of said base;
(d) a frame support which is disposed generally vertically when said hand truck is employed for transporting such load, said frame support including a pair of spaced-apart tubular members;
(e) a pair of second pivot means each for pivotally connecting a second end of a respective tubular member of said frame support to a respective one of said pair of elongated members of said base;
(f) a cradle having a first end thereof configured for abutting engagement with said load carrying frame of said hand truck and having a second end thereof being formed by a pair of spaced-apart elongated members each telescopically received within said respective tubular member of said frame support;
(g) a brace including a pair of spaced-apart tubular members and a pair of spaced-apart elongated members each telescopically received within a respective tubular member of said brace;
(h) a pair of third pivot means each for pivotally connecting a respective free end of one of said pair of tubular member of said brace to a respective tubular member of said frame support adjacent to and spaced from a first end thereof; and
(i) a pair of forth pivot means each for pivotally connecting a respective free end of one of said pair of elongated members of said brace to said respective elongated member of said base adjacent said first end thereof.

16. The apparatus, according to claim 15, wherein said each first pivot means includes a cutout which is formed through an elongated member of said base in open relationship with a first end thereof and which is sized to receive said axle of said hand truck, an aperture vertically formed through said base adjacent to and spaced from said first end of said elongated member and through said cutout, and an elongated fastener received within said aperture after said axle has been received within said cutout for pivotal caging therewithin.

17. The apparatus, according to claim 15, wherein said first end of said cradle includes a pair of spaced-apart vertically disposed members and a horizontal member joining each vertically disposed member at its lower end.
